(19) United States
(12) Patent Application Publication
(10) Pub. No.: US 2015/0347002 A1
(43) Pub. Date: Dec. 3, 2015

(54) ELECTRONIC DEVICE AND METHOD

(71) Applicant: Kabushiki Kaisha Toshiba, Tokyo (JP)

(72) Inventor: Shigeru Motoi, Kokubunji Tokyo (JP)

(21) Appl. No.: 14/823,479

(22) Filed: Aug. 11, 2015

Related U.S. Application Data
(63) Continuation of application No. PCT/JP2013/076233, filed on Sep. 27, 2013.

(51) Int. Cl. G06F 3/0488; G06K 9/00; G06F 3/0354; G06F 3/044; G06F 3/046

(52) U.S. Cl. CPC G06F 3/04883; G06F 3/044; G06F 3/046; G06F 3/03545; G06K 9/00865; G06F 2203/04104; G06F 2203/04808

(57) ABSTRACT

According to one embodiment, an electronic device outputs a first value used for display of content when an object is not in contact with a first area on a screen, and when a distance between the first area and the object is smaller than or equal to a first threshold value and greater than a second threshold value, and outputs a second value different from the first value used for the display of the content when the object is not in contact with the first area on the screen, and when the distance between the first area and the object is smaller than or equal to the second threshold value and greater than a third threshold value. The device displays the content based on the first value or the second value.

### CROSS REFERENCE TO RELATED APPLICATIONS

This application is a Continuation Application of PCT Application No. PCT/JP2013/076233, filed Sep. 27, 2013, the entire contents of which are incorporated herein by reference.

### FIELD

Embodiments described herein relate generally to technology of displaying or reproducing content.

### BACKGROUND

In recent years, various electronic devices such as a tablet, a PDA, and a smartphone have been developed. Most of the electronic devices of this type comprise a touchscreen display to facilitate a user input operation. In addition, electronic devices capable of inputting characters, etc. with a stylus have also been recently developed.

Conventionally, however, no consideration has been given to a technique for easily changing content display or reproduction at the time of displaying or reproducing the content.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device of one of embodiments.

FIG. 2 is an exemplary illustration showing collaborative operations of the electronic device of the embodiment and an external device.

FIG. 3 is an exemplary illustration showing an example of a handwritten document which is handwritten on a touchscreen display of the electronic device of the embodiment.

FIG. 4 is an exemplary illustration for explanation of time-series information corresponding to the handwritten document of FIG. 3 stored in a storage medium by the electronic device of the embodiment.

FIG. 5 is an exemplary block diagram showing a system configuration in the electronic device of the embodiment.

FIG. 6 is an exemplary illustration showing processing corresponding to turning a page using the stylus, executed by the electronic device of the embodiment.

FIG. 7 is an exemplary block diagram showing a functional configuration of a handwritten notebook application program executed by the electronic device of the embodiment.

FIG. 8 is a table showing summary of table data.

FIG. 9 is an exemplary flowchart showing steps of sequential page turn processing executed by the electronic device of the embodiment.

FIG. 10 is an exemplary illustration showing a message displayed before executing the sequential page turn processing.

FIG. 11 is an exemplary illustration showing a page feed button and a page return button of a small display size.

FIG. 12 is an exemplary illustration showing the page feed button and the page return button of a large display size.

### DETAILED DESCRIPTION

Various embodiments will be described hereinafter with reference to the accompanying drawings.

In general, according to one embodiment, an electronic device includes a processor capable of displaying content. The processor outputs a first value used for the display of the content when an object is not in contact with a first area on a screen, and when a distance between the first area and the object is smaller than or equal to a first threshold value and greater than a second threshold value. The processor outputs a second value different from the first value used for the display of the content when the object is not in contact with the first area on the screen, and when the distance between the first area and the object is smaller than or equal to the second threshold value and greater than a third threshold value. The processor displays the content based on the first value or the second value

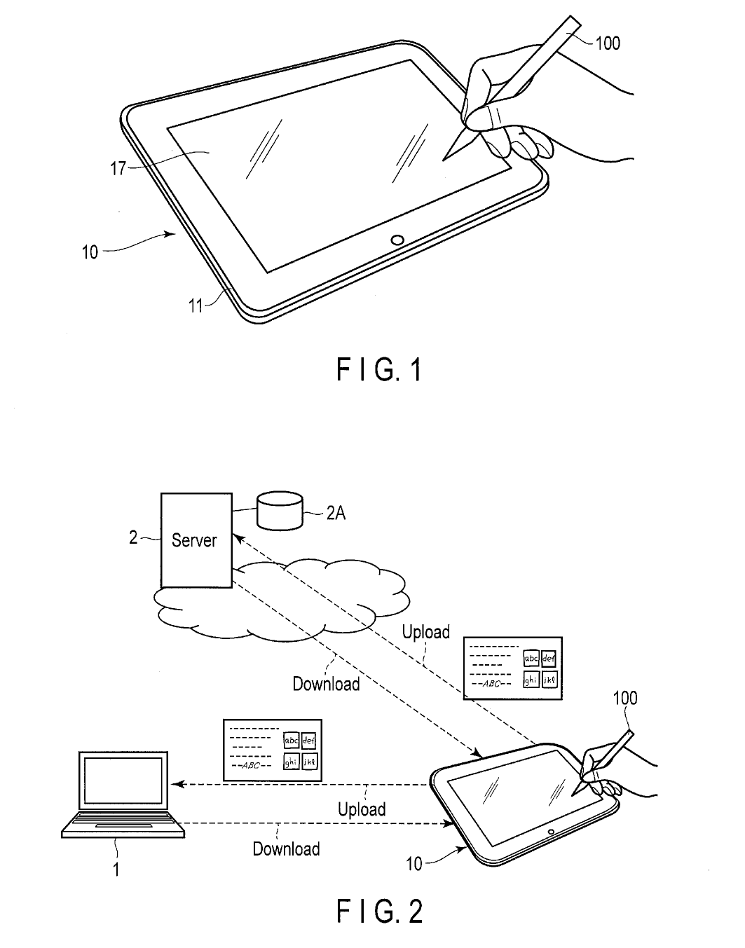

FIG. 1 is a perspective view showing an appearance of an electronic device of one of the embodiments. The electronic device is, for example, a stylus-based portable electronic device capable of handwriting input with a stylus or a finger. The electronic device can be realized as a tablet computer, a notebook-type personal computer, a smartphone, a PDA, etc. It is hereinafter assumed that the electronic device is realized as a tablet computer 10. The tablet computer 10 is a portable electronic device called a tablet or a slate computer and comprises a body 11 and a touchscreen display 17 as shown in FIG. 1. The touchscreen display 17 is mounted on the body 11 so as to be laid on an upper surface of the body 11.

The body 11 comprises a housing shaped in a thin box. In the touchscreen display 17, a flat-panel display and a sensor configured to detect the contact position of a stylus or a finger on the screen of the flat-panel display are incorporated. The flat-panel display may be, for example, a liquid-crystal display (LCD). As the sensor, for example, a capacitive touch panel or an electromagnetic-induction digitizer may be used. It is hereinafter assumed that two types of sensors, a digitizer and a touch panel, are incorporated in the touchscreen display 17.

The touchscreen display 17 can detect not only a touch operation on the screen with a finger but also a touch operation on the screen with a stylus 100. The stylus 100 may be, for example, a digitizer stylus (electromagnetic induction stylus).

The user can execute a handwriting input operation on the touchscreen display 17 with the stylus 100 (stylus input mode). In the handwriting input operation, a locus of a movement of the stylus 100 on the screen, i.e., a stroke handwritten by the handwriting input operation (locus of a handwritten stroke), is drawn in real time and plural strokes input by handwriting are thereby displayed on the screen. The locus of the movement of the stylus 100 formed while the stylus 100 is in touch with the screen corresponds to one stroke. A set of multiple strokes corresponding to a handwritten letter, a handwritten figure, a handwritten table, etc., constitutes a handwritten document.

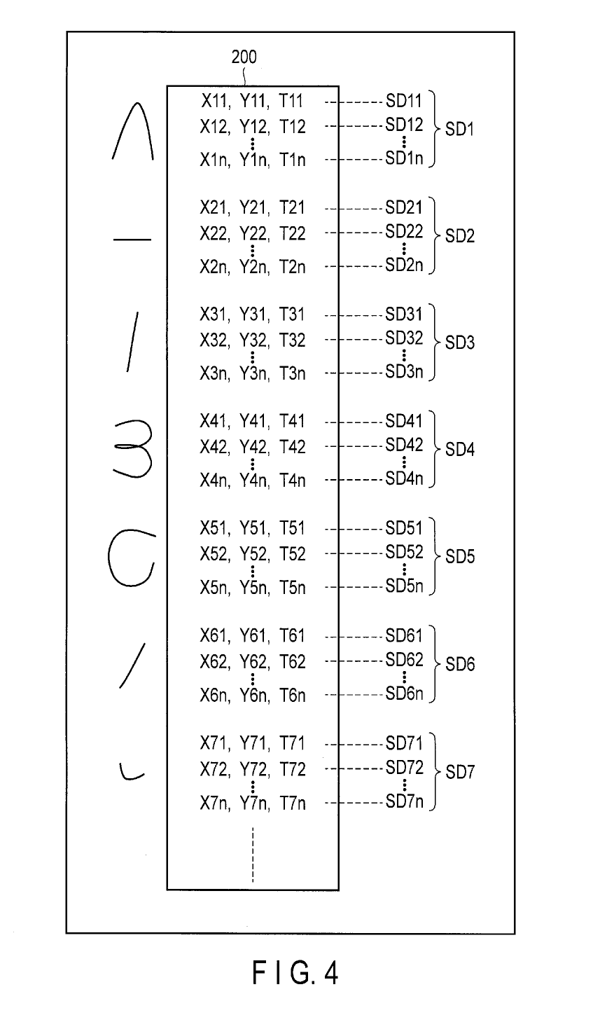

In the present embodiment, this handwritten document is stored in a storage medium as not image data, but time-series information (handwritten document data) representing coordinate sequences of the locus of each stroke and an order relationship between strokes. The time-series information, which will be described later in detail with reference to FIG. 4, indicates the order in which plural strokes were handwritten, and includes plural stroke data elements corresponding to the plural strokes, respectively. In other words, the time-series information means a set of time-series stroke data elements corresponding to the plural strokes, respectively. Each stroke data corresponds to a stroke and includes a coordinate data sequence (time-series coordinates) corresponding to each point on a locus of the stroke. The order of arrangement of these stroke data corresponds to the order in which the respective strokes were handwritten.

The tablet computer 10 can read an arbitrary existing time-series information from the storage medium and display a handwritten document corresponding to the time-series information, i.e., plural strokes shown by the time-series information, on the screen. The plural strokes indicated by the time-series information are also plural strokes input by handwriting.

Furthermore, the tablet computer 10 of the present embodiment also has a touch input mode capable of executing the handwriting input operation with not the stylus 100, but a finger. If the touch input mode is enabled, the user can execute the handwriting input operation with a finger, on the touchscreen display 17. In the handwriting input operation, a locus of a movement of the finger on the screen, i.e., a stroke handwritten by the handwriting input operation (locus of a handwritten stroke), is drawn in real time and plural strokes input by handwriting are thereby displayed on the screen.

The touch input mode can use as an input mode capable of temporarily executing the handwriting input operation corresponding to the movement of a finger on the screen. Even if the user forgets carrying the stylus 100, the user can execute the handwriting input operation with a finger by enabling the touch input mode.

The tablet computer 10 further has an edit function. The edit function can delete or move an arbitrary handwritten portion (handwritten character, handwritten mark, handwritten figure, handwritten table or the like) in a currently displayed handwritten document, which is selected by a range selection tool, based on an edit operation executed by the user using an “eraser” tool, the range selection tool, other various tools, etc. Furthermore, the arbitrary handwritten portion in the handwritten document, which is selected by the range selection tool, can be designated as a search key for searching the handwritten document. Moreover, recognition processing such as handwritten character recognition/handwritten figure recognition/handwritten table recognition can be executed for the arbitrary handwritten portion in the handwritten document, which is selected by the range selection tool.

In the present embodiment, the handwritten document can be managed as one or plural pages. In this case, a set of elements of time-series information fitting in a screen can be recorded as one page, by separating the time-series information (handwritten document data) in units of an area that fits in a screen. Alternatively, the size of a page may be set to be variable. In this case, since the size of a page can be made larger than the size of one screen, a handwritten document having an area larger than the size of the screen can be handled as one page. If the whole of one page cannot be displayed on the display at once, the page may be reduced in size or a portion to be displayed in the page may be moved by vertical and horizontal scrolling.

FIG. 2 shows collaborative operations of the tablet computer 10 and an external device. The tablet computer 10 can cooperate with a personal computer 1 or a cloud. More specifically, the tablet computer 10, which comprises a wireless communication device for a wireless LAN, etc., can execute wireless communication with the personal computer 1. Furthermore, the tablet computer 10 can also communicate with a server 2 on the Internet. The server 2 may be a server which implements on-line storage services or other various cloud computing services.

The personal computer 1 comprises a storage device such as a hard disk drive (HDD). The tablet computer 10 can transmit the time-series information (handwritten document data) to the personal computer 1 via a network and record the time-series information in the HDD of the personal computer 1 (“uploading”). To assure secure communication between the tablet computer 10 and the personal computer 1, the personal computer 1 may authenticate the tablet computer 10 at the start of communication. In this case, a dialog which prompts the user to input an ID or a password may be displayed on the screen of the tablet computer 10 or the ID of the tablet computer 10, etc., may be transmitted automatically from the tablet computer 10 to the personal computer 1.

This enables the tablet computer 10 to handle a large number of elements of time-series information or a large amount of time-series information even when the capacity of the storage in the tablet computer 10 is low.

Furthermore, the tablet computer 10 can read at least one arbitrary element of the time-series information recorded on the HDD of the personal computer 1 (“downloading”) and display strokes indicated by the read time-series information on the screen of the display 17 of the tablet computer 10. In this case, a list of thumbnails obtained by reducing each page of the plural elements of time-series information may be displayed on the screen of the display 17 or one page selected from the thumbnails may be displayed in a normal size on the screen of the display 17.

Furthermore, a destination with which the tablet computer 10 communicates may not be the personal computer 1, but may be the server 2 on a cloud which provides storage services as explained above. The tablet computer 10 can transmit the time-series information (handwritten document data) to the server 2 via a network and record the time-series information in a storage device 2A of the server 2 (“uploading”). Moreover, the tablet computer 10 can read an arbitrary element of time-series information recorded in the storage device 2A of the server 2 (“downloading”) and display a locus of each stroke shown by the time-series information on the display 17 of the tablet computer 10.

As described above, in the present embodiment, the storage medium in which time-series information is stored may be any one of the storage device in the tablet computer 10, the storage device in the personal computer 1, and the storage device of the server 2.

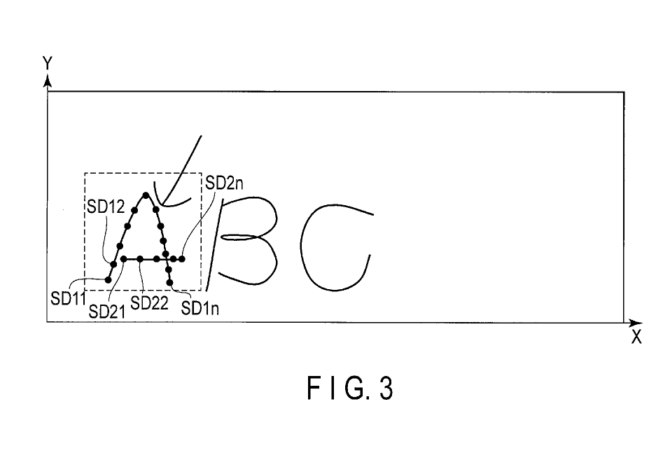

Next, a relationship between a stroke (character, figure, table, etc.) handwritten by the user and the time-series information will be explained with reference to FIG. 3 and FIG. 4. FIG. 3 shows an example of a handwritten document (handwritten character string) handwritten on the touchscreen display 17 with a stylus 100, etc.

In the handwritten document, another character or figure is often handwritten over an already handwritten and input character or figure. In FIG. 3, it is assumed that a handwritten character string “ABC” is input by handwriting in order of “A”, “B”, and “C” and that a handwritten arrow is next input by handwriting at a position very close to the handwritten letter “A”.

The handwritten letter “A” is represented by two strokes (a “̂”-shaped locus and a “-”-shaped locus) handwritten with the stylus 100, etc., that is, by two loci. The first handwritten “̂” -shaped locus of the stylus 100 is sampled in real time at equal intervals of time, and time-series coordinates SD11, SD12, . . . , SD1n of the “̂” -shaped stroke are thereby obtained. Similarly, the next handwritten “-”-shaped locus of the stylus 100 is also sampled in real time at equal intervals of time, and time-series coordinates SD21, SD22, . . . , SD2r of the “-”-shaped stroke are obtained.

The handwritten letter “B” is represented by two strokes handwritten with the stylus 100, etc., that is, by two loci. The handwritten letter “C” is represented by one stroke handwritten with the stylus 100, etc., that is, by one locus. A handwritten arrow is represented by two strokes handwritten with the stylus 100, etc., that is, by two loci.

FIG. 4 shows time-series information 200 corresponding to the handwritten document shown in FIG. 3. The time-series information includes plural stroke data SD1, SD2, . . . , SD7. In the time-series information 200, these stroke data SD1, SD2, . . . , SD7 are arranged chronologically in the order in which the strokes have been handwritten.

In the time-series information 200, the first two stroke data SD1 and SD2 represent two strokes of the handwritten letter “A”, respectively. The third and fourth stroke data SD3 and SD4 represent two strokes constituting the handwritten letter “B”, respectively. The fifth stroke data SD5 represents one stroke constituting the handwritten letter “C”. The sixth and seventh stroke data SD6 and SD7 represent two strokes constituting the handwritten arrow, respectively.

Each stroke data includes a coordinate data sequence (time-series coordinates) corresponding to one stroke, that is, plural coordinates corresponding to plural points on a locus of one stroke, respectively. In each stroke data, plural coordinates are arranged chronologically in the order in which the stroke has been written. For example, as for the handwritten letter “A”, the stroke data SD1 includes coordinate data sequences (time-series coordinates) corresponding to the respective points on a locus of the “̂”-shaped stroke in the handwritten letter “A”, i.e., n coordinate data elements SD11, SD12, . . . , SD1n. The stroke data SD2 includes a coordinate data sequence corresponding to the points on a locus of the “-”-shaped stroke in the handwritten letter “A”, i.e., n coordinate data elements SD21, SD22, . . . , SD2n. It should be noted that the number of coordinate data elements may differ in stroke data elements.

Each coordinate data represents an x-coordinate and a y-coordinate corresponding to a point in the corresponding locus. For example, coordinate data SD11 represents X-coordinate (X11) and Y-coordinate (Y11) of the start point of the “A”-shaped stroke. SD1n represents X-coordinate (X1n) and Y-coordinate (Yin) of the end point of the “A”-shaped stroke.

Furthermore, each coordinate data may include time stamp information T corresponding to a time point at which a point corresponding to the coordinates has been handwritten. The time point at which the point has been handwritten may be either an absolute time (for example, year, month, day, hours, minutes, and seconds) or a relative time based on a certain time point. For example, an absolute time (for example, year, month, day, hours, minutes, and seconds) at which a stroke started being written may be added to each stroke data element as the time stamp information, and a relative time representing the difference from the absolute time may be further added to each coordinate data element in the stroke data element as time stamp information T.

Thus, a temporal relationship between strokes can be represented more accurately by using the time-series information in which the time stamp information T has been added to each coordinate data element.

Furthermore, information (Z) indicating a writing pressure may be added to each coordinate data element.

The time-series information 200 having the structure explained with reference to FIG. 4 can represent not only the handwriting of each stroke, but also the temporal relationship between strokes. Therefore, even if a tip portion of the handwritten arrow has been written so as to overlap the handwritten letter “A” or to be close to the handwritten letter “A” as shown in FIG. 3, the handwritten letter “A” and the handwritten tip portion of the arrow can be treated as different letters or figures by using the time-series information 200.

Moreover, in the present embodiment, since the handwritten document data is stored as not images or character recognition results, but the time-series information 200 composed of a set of time-series stroke data as explained above, handwritten characters can be handled independently of the language of handwritten characters. Therefore, the structure of the time-series information 200 in the present embodiment can be used commonly in various countries differing in language around the world.

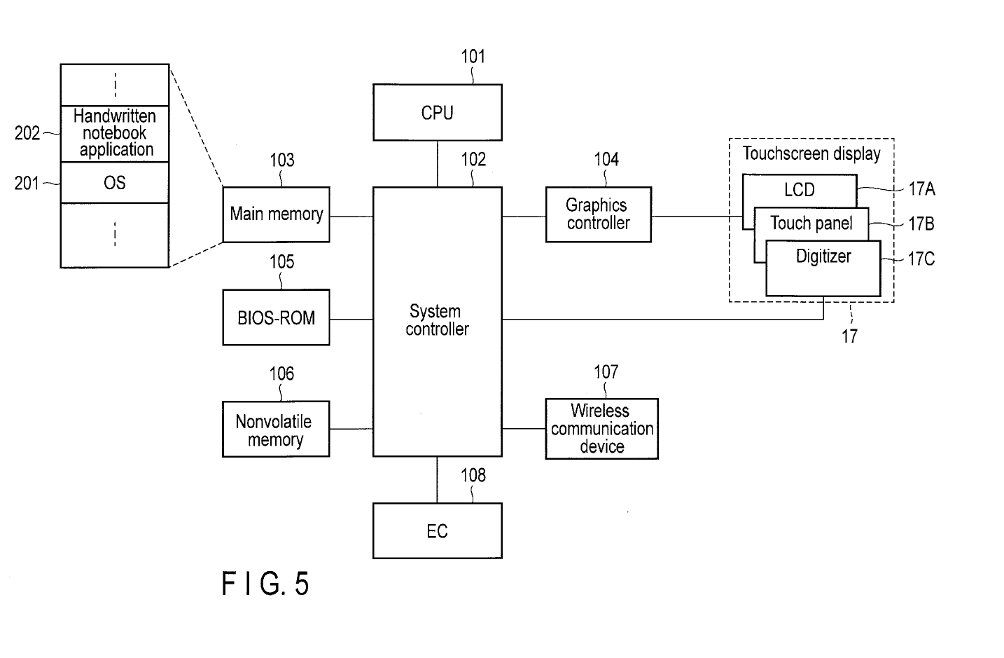

FIG. 5 shows a system configuration of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor which controls the operations of various modules in the tablet computer 10. The CPU 101 executes various software programs loaded from the nonvolatile memory 106 serving as a storage device to the main memory 103. These software programs include an operating system (OS) 201 and various application programs. The application programs include a handwritten notebook application program 202.

The handwritten notebook application program 202 has a function of creating and displaying the above-explained handwritten document data, a function of editing handwritten page data, and a handwritten document search function of searching for handwritten document data including a desired handwritten portion, and a desired handwritten portion in certain handwritten document data.

In addition, the CPU 101 also executes a basic input/output system (BIOS) stored in the BIOS-ROM 105. The BIOS is a program for hardware control.

The system controller 102 is a device which makes connection between a local bus of the CPU 101 and various components. The system controller 102 incorporates a memory controller which controls access to the main memory 103. In addition, the system controller 102 also has a function of communicating with the graphics controller 104 via a serial bus conforming to the PCI EXPRESS standard.

The graphics controller 104 is a display controller which controls an LCD 17A used as a display monitor of the tablet computer 10. A display signal generated by the graphics controller 104 is transmitted to the LCD 17A. The LCD 17A displays a screen image, based on the display signal. A touch panel 17B, an LCD 17A and a digitizer 17C are superposed on each other. The touch panel 17B is a capacitive pointing device for inputting on the screen of the LCD 17A. The contact position on the screen where a finger touches, and the movement of the contact position, etc., are detected by the touch panel 17B. The digitizer 17C is an electromagnetic pointing device for inputting on the screen of the LCD 17A. The contact position on the screen where the stylus (digitizer stylus) 100 touches, the movement of the contact position, etc., are detected by the digitizer 17C.

The digitizer 17C can detect a distance (height) between the screen and the digitizer. Plural coils (antenna coils) are arranged in the digitizer 17C. In addition, a coil and a capacitor connected to both ends of the coil are provided in the stylus 100. An alternate current flows through each of the coils in the digitizer 17C for a certain period. The antenna coils in the digitizer 17C and the coil in the stylus 100 perform similarly to primary and secondary sides of a transformer, and an alternate voltage is generated at both ends of the coil in the stylus 100. Since the coil in the stylus 100 and the capacitor constitute a resonant circuit, energy is stored by LC resonance. The digitizer 17C stops supply of the alternate current after the resonance becomes stable. Electric power of the resonant circuit in the stylus 100 appears at the coil in the digitizer 17C while the coil of the stylus 100 serves as the primary side and the coil of the digitizer 17C serves as the secondary side. The voltages of the coils of the digitizer 17C which supply the alternate current in the digitizer 17C are measured. A position of the coil of the highest measured voltage, of the plural coils in the digitizer 17C, corresponds to the position of the stylus 100 in a plane parallel to the screen, on the screen. In addition, the voltage value corresponds to a distance between the digitizer 17C and the stylus 100. The voltage value is greater as the distance is shorter. In other words, the voltage value is smaller as the distance is longer.

In addition, a lead (core) of the stylus 17C moves in response to a force (writing pressure) applied to the lead. An inductance of the coil in the stylus 100 is varied, depending on the amount of movement of the lead. The stylus 100 varies a frequency of the alternate current flowing to the resonant circuit in response to the writing pressure. The digitizer 17C detects the writing pressure, based on the variation in frequency. If the writing pressure is not greater than zero, the writing pressure indicates that the stylus 100 is not in contact with the surface of the touchscreen display 17. If the writing pressure is greater than zero, the writing pressure indicates that the stylus 100 is in contact with the surface of the touchscreen display 17.

The digitizer 17C outputs the positional information indicating the position of the stylus 100 in the plane parallel to the screen, on the screen. In addition, the digitizer 17C outputs distance information including the value of the voltage corresponding to the distance between the screen and the stylus 100. The digitizer 17C outputs writing pressure information indicating the writing pressure.

The wireless communication device 107 is a device configured to execute wireless communication such as a wireless LAN or a 3G mobile communication. The EC 108 is a one-chip microcomputer which includes an embedded controller for power management. The EC 108 has the function of turning on or off the power supply of the tablet computer 10, based on the user's operation of a power button.

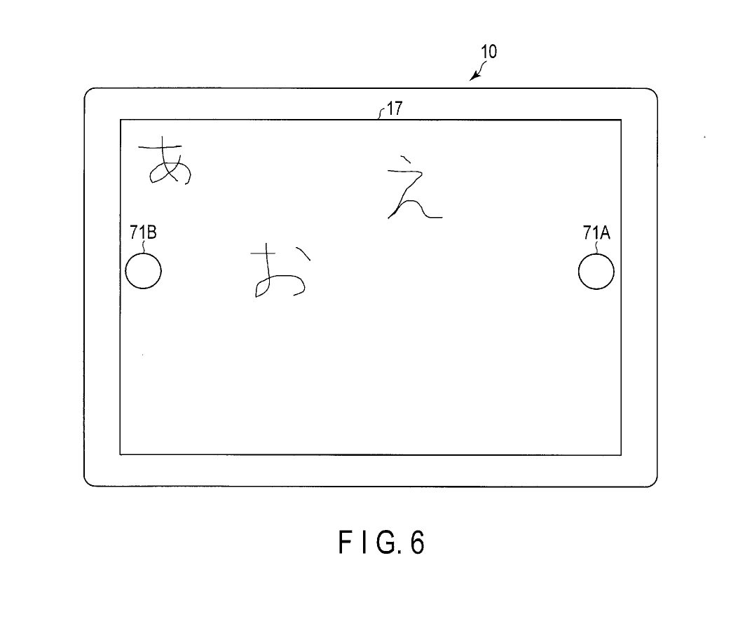

FIG. 6 shows processing corresponding to turning a page using the stylus 100, which is executed by the tablet computer 10.

The handwritten notebook application program 202 displays the handwritten document on the touchscreen display 17. If the handwritten document includes plural pages, the handwritten notebook application program 202 displays a page feed button 71A and a page return button 71B as page turn buttons, on the handwritten document. For example, when a lead tip of the stylus 100 is brought into contact with an area on the touchscreen display 17 corresponding to the page feed button 71A, the handwritten notebook application program 202 displays a next page of the currently displayed page. In addition, the lead tip of the stylus 100 is brought into contact with an area on the touchscreen display 17 corresponding to the page return button 71B, the handwritten notebook application program 202 displays a previous page of the currently displayed page.

When the lead tip of the stylus 100 is located away from the touchscreen display 17 on the page feed button 71A (that is, the tip of the stylus 10 is not in contact with the touchscreen display 17 and is located above the area on the touchscreen display 17 corresponding to the page turn button 71A), the handwritten notebook application program 202 executes sequential page turn processing of sequentially displaying next pages of the displayed pages at a speed corresponding to the distance between the area on the touchscreen display 17 corresponding to the page turn button 71A and the lead tip of the stylus 100.

When the lead tip of the stylus 100 is located away from the touchscreen display 17 on the page return button 71B (that is, the tip of the stylus 10 is not in contact with the touchscreen display 17 and is located above the area on the touchscreen display 17 corresponding to the page return button 71B), the handwritten notebook application program 202 executes sequential page turn processing of sequentially displaying previous pages of the displayed pages at a speed corresponding to the distance between the area on the touchscreen display 17 corresponding to the page turn button 71B and the lead tip of the stylus 100.

It should be noted that the page feed button 71A and the page return button 71B are often hereinafter called page feed buttons 71.

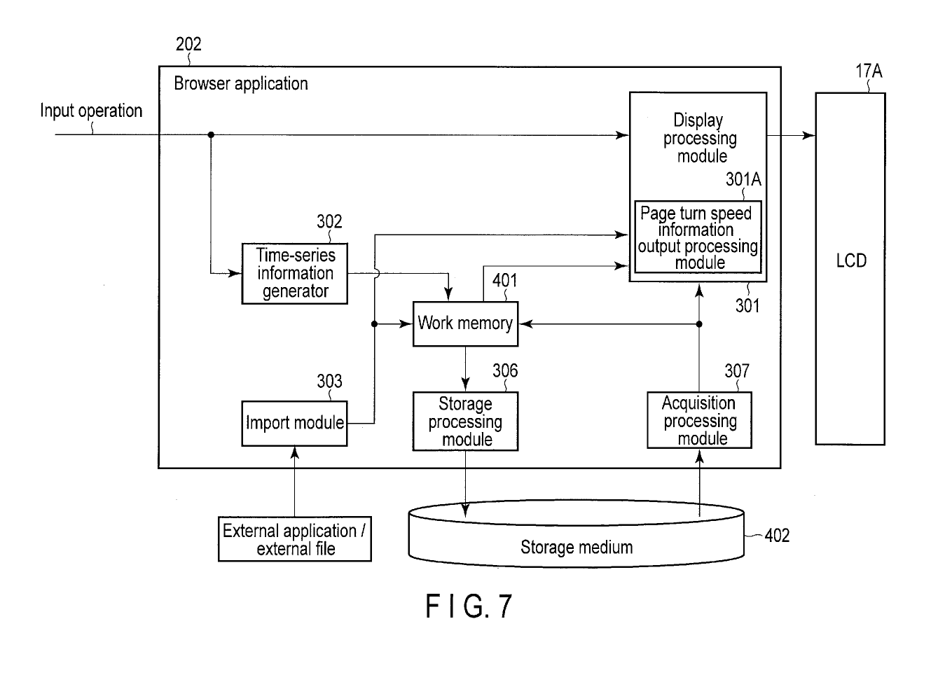

FIG. 7 is a block diagram showing a configuration of the handwritten notebook application program 202.

The handwritten notebook application program 202 is a WYSIWYG application capable of handling the handwritten document data. The handwritten notebook application program 202 comprises, for example, a display processing module 301, a time-series information generator 302, an import module 303, a storage processing module 306, an acquisition processing module 307, etc.

The above-explained touch panel 17B is configured to detect occurrence of events such as “touch (contact)”, “move (slide)” and “release”. “Touch (contact)” is an event indicating that an object (finger or stylus 100) has made contact with the screen. “Move (slide)” is an event indicating that the contact position is moved while the object (finger or stylus 100) is in contact with the screen. “Release” is an event indicating that the object (finger or stylus 100) has been moved away from the screen.

The above-explained digitizer 17C is also configured to detect occurrence of events such as “touch (contact)”, “move (slide)” and “release”. “Touch (contact)” is an event indicating that an object (stylus 100) has made contact with the screen. “Move (slide)” is an event indicating that the contact position is moved while the object (stylus 100) is in contact with the screen. “Release” is an event indicating that the object (stylus 100) has been moved away from the screen.

The handwritten notebook application program 202 displays a page edit screen for creation, viewing and edition of the handwritten page data on the touchscreen display 17.

The display processing module 301 and the time-series information generator 302 receive the event “touch (contact)”, “move (slide)” or “release” which is caused to occur by the digitizer 17C, and thereby detects the handwriting input operation. Coordinates of the contact position of the stylus 100 are included in the “touch (contact)” event. Coordinates of the contact position of a movement destination of the stylus 100 are included in the “move (slide)” event. Thus, the display processing module 301 and the time-series information generator 302 can receive a series of coordinates corresponding to a locus of movement of the touch position from the digitizer 17C.

Similarly, the display processing module 301 and the time-series information generator 302 can receive the event “touch (contact)”, “move (slide)” or “release” which is caused to occur by the touch panel 17B. Coordinates of the contact position of the finger are included in the “touch (contact)” event. Coordinates of the contact position of a movement destination of the finger are included in the “move (slide)” event. Thus, the display processing module 301 and the time-series information generator 302 can receive a series of coordinates corresponding to a locus of movement of the touch position from the touch panel 17B.

The display processing module 301 can display various types of content data (image data, speech data, text data, and data created by a drawing application) imported from an external application/external file by an import module 303, on the page edit screen.

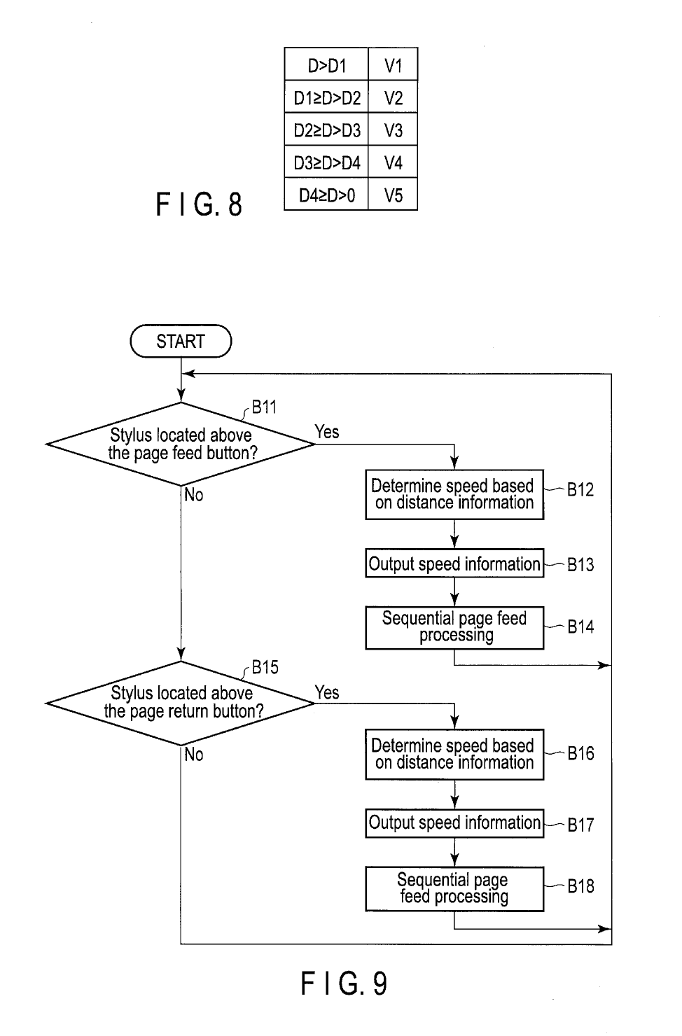

Furthermore, the display processing module 301 comprises a page turn speed information output processing module 301A. The page turn speed information output processing module 301A acquires the position information and distance information D from the digitizer 17C. If the position information indicates an inside of the display area of the page turn button 71, the page turn speed information output processing module 301A outputs speed information determined based on the distance information D. The page turn speed information output processing module 301A comprises table data shown in FIG. 8. The distance information D indicates a smaller value as the distance from the display to the stylus is longer. In other words, the distance information D indicates a greater value as the distance from the display to the stylus is shorter.

If the distance information D is greater than threshold value D1, the page turn speed information output processing module 301A selects speed V1. If the distance information D is not greater than D1 but greater than D2, the page turn speed information output processing module 301A selects speed V2. If the distance information D is not greater than D2 but greater than D3, the page turn speed information output processing module 301A selects speed V3. If the distance information D is not greater than D3 but greater than D4, the page turn speed information output processing module 301A selects speed V4. If the distance information D is not greater than D4 but greater than 0, the page turn speed information output processing module 301A selects speed V5.

The relationship among D1, D2, D3, D4, and D5 is D1>D2>D3>D4>D5. The relationship among V1, V2, V3, V4, and V5 may be V1>V2>V3>V4>V5 or V1<V2<V3<V4<V5.

When the stylus 100 is not in contact with the page feed button 71A on the screen and is located above the page feed button 71A, the display processing module 301 executes sequential page feed processing of sequentially displaying next pages of the displayed pages of the handwritten document, at a speed corresponding to the speed information output from the page turn speed information output processing module 301A. When the stylus 100 is not in contact with the page return button 71B on the screen and is located above the page return button 71B, the display processing module 301 executes sequential page return processing of sequentially displaying previous pages of the displayed pages of the handwritten document, at a speed corresponding to the speed information output. from the page turn speed information output processing module 301A.

The time-series information generator 302 receives the above-explained series of coordinates (input event group) output from the touch digitizer 17C, and generates handwritten data including the time-series information (coordinate data sequence) having the structure as explained in detail with reference to FIG. 4, based on the received series of coordinates. The time-series information generator 302 temporarily stores the generated handwritten data in the work memory 401. Also, the time-series information generator 302 may receive the above-explained series of coordinates (input event group) output from the touch panel 17B, and may generate handwritten data including the time-series information (coordinate data sequence) having the structure as explained in detail with reference to FIG. 4, based on the received series of coordinates.

The storage processing module 306 stores the handwritten page data including the plural stroke data corresponding to the plural handwritten strokes on the handwritten page which is being edited, in the storage medium 402. The storage medium 402 may be, for example, the storage device in the tablet computer 10 or the storage device of the server computer 2.

The acquisition processing module 307 acquires arbitrary handwritten page data from the storage medium 402. The acquired handwritten page data 301 is sent to the display processing module 301. The display processing module 301 displays plural strokes corresponding to the plural stroke data included in the handwritten page data, on the screen.

FIG. 9 is a flowchart showing steps of sequential page turn processing.

The page turn speed information output processing module 301A determines whether the stylus 100 is located above the page feed button 71A, based on the position information and the writing pressure information (step B11). If it is determined that the stylus 100 is located above the page feed button 71A (Yes in step B11), the page turn speed information output processing module 301A selects the page feed speed, based on the distance information D and the table shown in FIG. 8 (step B12). The page turn speed information output processing module 301A outputs the speed information indicating the selected page feed speed (step B13). That is, when the object such as stylus 100 is not in contact with the screen and when the distance between the area on the screen corresponding to the page feed button 71A and the object is smaller than or equal to a first threshold value and greater than a second threshold value, the page turn speed information output processing module 301A outputs the speed information indicating a first value. When the object such as stylus 100 is not in contact with the screen and when the distance between the area on the screen corresponding to the page feed button 71A and the object is smaller than or equal to the second threshold value and greater than a third threshold value, the page turn speed information output processing module 301A outputs the speed information indicating a second value different from the first value. The display processing module 301 executes the sequential page feed processing of sequentially displaying next pages of the displayed pages of the handwritten document, based on the speed information (step B14).

If it is determined that the stylus 100 is not located above the page feed button 71A (Yes in step B12), the page turn speed information output processing module 301A determines whether the stylus 100 is located above the page return button 71B, based on the position information and the writing pressure information (step B15). If it is determined that the stylus 100 is located above the page return button 71B (Yes in step B15), the page turn speed information output processing module 301A selects the page feed speed, based on the distance information D and the table shown in FIG. 8 (step B16). The page turn speed information output processing module 301A outputs the speed information indicating the speed obtained by applying a minus sign to the selected page feed speed (step B17). The display processing module 301 executes the sequential page return processing of sequentially displaying previous pages of the displayed pages of the handwritten document, based on the speed information (step B18).

The sequential page turn processing may be executed immediately when the stylus is located above the page turn button. Alternatively, the sequential page turn processing may not be executed immediately when the stylus is located above the page turn button, but may be started when the status in which the stylus is located above the page turn button continues for a set time or more.

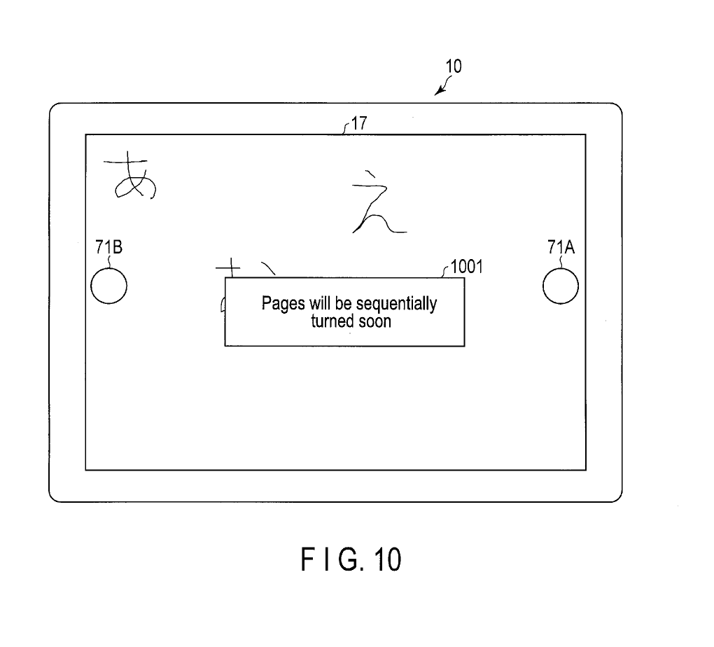

When the stylus is located above the page turn button, a message 1001 indicating that the sequential page turn processing will be executed may be displayed, as shown in FIG. 10. The sequential page turn processing may be executed after the set time has elapsed since the display of the message 1001.

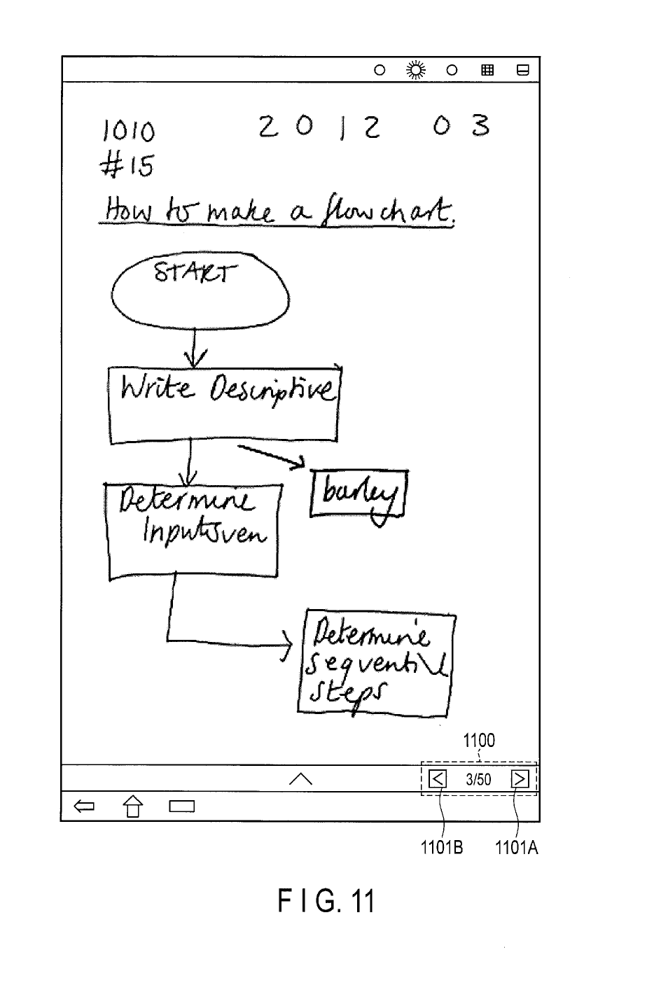

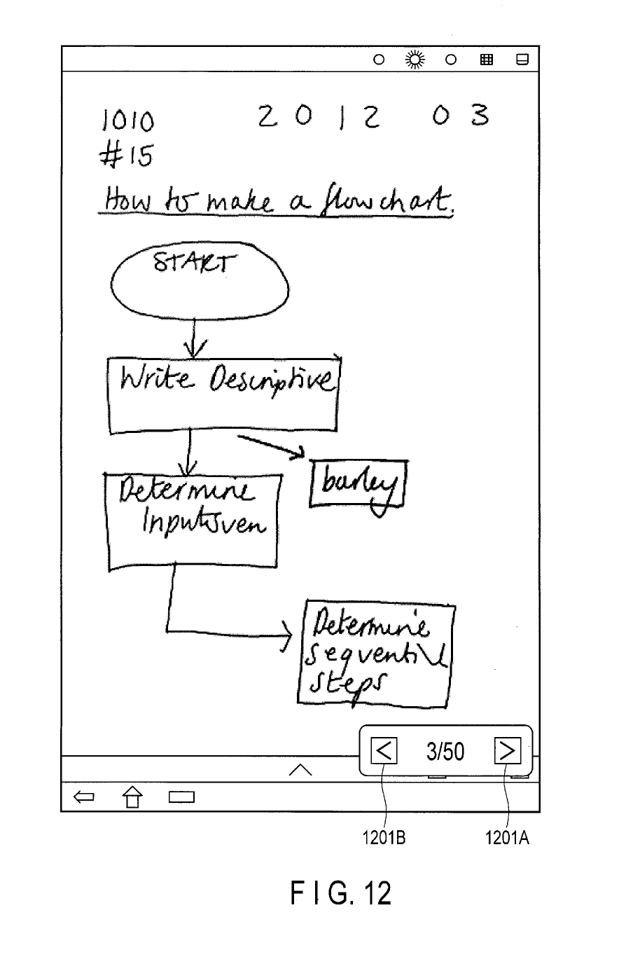

In addition, if a display size of a page feed button 1101A and a page return button 1101B is small as shown in FIG. 11, the stylus can hardly continue being located above the page feed button 1101A and the page return button 1101B. In this case, if the stylus is located above an area 1100 including the page feed button 1101A and the page return button 1101B, the page feed button 1101A and the page return button 1101B of a large size may be displayed as shown in FIG. 12.

In addition, the above-explained method can also be employed when pages displayed on not only the handwritten document, but also an electronic document including text data, etc. are turned.

It should be noted that at reproduction and display of a moving image and music, the moving image and music may be reproduced at a reproduction speed determined based on the distance between the button and the stylus. At display of an image, the image may be displayed at a display scaling factor (magnification ratio and reduction ratio) determined based on the distance between the button and the stylus.

A bar indicating the speed may be displayed. A seek bar indicating a displayed or reproduced portion of all contents may be displayed. Alternatively, the button may not be usually displayed, but displayed if the stylus approaches the surface of the touchscreen display 17.

At display and reproduction of contents such as documents, moving images, music, images, etc., a first value used for display and reproduction of the contents is output if the stylus is located above the button displayed on the screen and if the distance between the screen and the object is longer than a threshold value, a second value used for display and reproduction of the contents is output if the object is located above the button and if the distance between the button and the object is not longer than the threshold value, processing of displaying or reproducing the contents on the screen is executed based on the first value or the second value, and the display or reproduction of the contents can easily be thereby changed.

In addition, since various types of the processing of the present embodiment can be implemented by the computer program, the same advantage as that of the present embodiment can easily be obtained by merely installing the computer program via a computer-readable storage medium storing the computer program in a general computer and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor capable of displaying content,
wherein:
the processor is configured to:
output a first value used for the display of the content when an object is not in contact with a first area on a screen, and when a distance between the first area and the object is smaller than or equal to a first threshold value and greater than a second threshold value;
output a second value different from the first value used for the display of the content when the object is not in contact with the first area on the screen, and when the distance between the first area and the object is smaller than or equal to the second threshold value and greater than a third threshold value; and
display the content based on the first value or the second value.

2. The electronic device of claim 1, wherein
the processor is further configured to start the display of the content when a state continues for at least a first time period, the state in which the distance between the first area and the object is smaller than or equal to the first threshold value and greater than the second threshold value or the distance between the first area and the object is smaller than or equal to the second threshold value and greater than the third threshold value.

3. The electronic device of claim 1, wherein
when the content is an electronic document comprising pages, the processor sequentially displays next or previous pages of the electronic document on the screen at a speed based on the first value or the second value.

4. The electronic device of claim 1, wherein
when the content is an electronic document comprising a moving image or music, the processor reproduces the moving image or the music at a speed based on the first value or the second value.

5. The electronic device of claim 1, wherein
when the content is an image, the processor displays the image at a magnification based on the first value or the second value.

6. A method comprising:
outputting a first value used for displaying content when an object is not in contact with a first area on a screen, and when a distance between the first area and the object is smaller than or equal to a first threshold value and greater than a second threshold value;
outputting a second value different from the first value used for displaying the content when the object is not in contact with the first area on the screen, and when the distance between the first area and the object is smaller than or equal to the second threshold value and greater than a third threshold value; and
displaying the content in a displaying manner based on the first value or the second value.

7. The method of claim 6, wherein
the displaying the content starts when a state continues for at least a first time period, the state in which the distance between the first area and the object is smaller than or equal to the first threshold value and greater than the second threshold value or the distance between the first area and the object is smaller than or equal to the second threshold value and greater than the third threshold value.

8. The method of claim 6, wherein
when the content is an electronic document comprising pages, the displaying the content comprises sequentially displaying next or previous pages of the electronic document on the screen at a speed based on the first value or the second value.

9. The method of claim 6, wherein
when the content is an electronic document comprising a moving image or music, the displaying the content comprises reproducing the moving image or the music at a speed based on the first value or the second value.

10. The method of claim 6, wherein
when the content is an image, the displaying the content comprises displaying the image at a magnification based on the first value or the second value.

11. A computer-readable, non-transitory storage medium having stored thereon a computer program which is executable by a computer, the computer program controlling the computer to execute functions of:
outputting a first value used for displaying content when an object is not in contact with a first area on a screen, and when a distance between the first area and the object is smaller than or equal to a first threshold value and greater than a second threshold value;
outputting a second value different from the first value used for displaying the content when the object is not in contact with the first area on the screen and when the distance between the first area and the object is smaller than or equal to the second threshold value and greater than a third threshold value; and
displaying the content in a displaying manner based on the first value or the second value.

12. The storage medium of claim 11, wherein
the displaying the content starts when a state continues for at least a first time period, the state in which the distance between the first area and the object is smaller than or equal to the first threshold value and greater than the second threshold value or the distance between the first area and the object is smaller than or equal to the second threshold value and greater than the third threshold value continues for a first time period or more.

13. The storage medium of claim 11, wherein
when the content is an electronic document comprising pages, the displaying the content comprises sequentially displaying next or previous pages of the electronic document on the screen at a speed based on the first value or the second value.

14. The storage medium of claim 11, wherein
when the content is an electronic document comprising a moving image or music, the displaying the content comprises reproducing the moving image or the music at a speed based on the first value or the second value.

15. The storage medium of claim 11, wherein
when the content is an image, the displaying the content comprises displaying the image at a magnification based on the first value or the second value.
